(19) United States
(12) Patent Application Publication
(10) Pub. No.: US 2025/0230826 A1
(43) Pub. Date: Jul. 17, 2025

(54) QUICK RELEASE STRUCTURE

(71) Applicant: Tymphany HK Limited, Wanchai (HK)

(72) Inventors: TUNGWEN TU, Taipei City (TW); CHITAI HO, Taipei City (TW)

(21) Appl. No.: 19/014,630

(22) Filed: Jan. 9, 2025

Related U.S. Application Data
(60) Provisional application No. 63/619,943, filed on Jan. 11, 2024.

(51) Int. Cl. F16B 5/02

(52) U.S. Cl. CPC F16B 5/0208; F16B 2200/83

(57) ABSTRACT

A quick release structure assembly is includes a first assembly component with a first body, a first combination piece, and an elastic piece, and a second assembly component with a second body, a second combination piece, and a ramp. The first body has a first holding groove, and the first combination piece is disposed in the first holding groove. The second body has a second holding groove at the end face of the ramp, and the second combination piece is disposed inside the second holding groove. The end face of the ramp has two opposite locking and unlocking sides. When the end face is assembled into the first holding groove, the first and second combination pieces are magnetically fixed. A locked state is achieved when the locking side corresponds to the elastic piece, and an unlocked state is achieved when the unlocking side corresponds to the elastic piece.

### CROSS-REFERENCE TO RELATED APPLICATIONS

This application claims priority of U.S. Provisional Application No. 63/619,943 filed on Jan. 11, 2024 under 35 USC § 119(e), the entire contents of which are hereby incorporated by reference.

### BACKGROUND

### 1. Technical Field

The present invention relates to a lock structure, and more particularly, to a quick release structure.

### 2. Description of the Related Art

General consumer electronics markets and daily life often require the use of peripheral accessories for various products. Peripheral accessories are used in various ways, such as quick release structures or designs with quick release structures on the product body, to meet the corresponding quick release structure needs of the products. Some examples of such products are cameras, phones, earphones, portable fans, and helmets. The quick release structure needs to be designed to meet different use requirements to provide users with a good operating experience. However, existing products cannot meet these needs.

### SUMMARY

The present invention provides a quick release structure that simply combines the first and second assembly components using magnetic attraction and a locking mechanism, which can be applied to most devices that require a quick release structure, avoiding the problem of being applicable to only a few devices.

To solve the aforementioned technical problem, the present invention is implemented as follows.

The present invention provides a quick release structure, which includes a first assembly component and a second assembly component. The first assembly component has a first body, a first combination piece, and an elastic piece. The first body has a first holding groove. The first combination piece is disposed in the first holding groove. The elastic piece is disposed at an opening of the first holding groove. The second assembly component has a second body and a second combination piece. The second body has a ramp; an end face of the ramp has a second holding groove. The second combination piece is disposed in the second holding groove. The ramp has two locking sides and two unlocking sides at the end face, and the end face of the ramp is assembled with the first holding groove of the first assembly component. The first combination piece and the second combination piece are fixed together magnetically; wherein, when the locking sides of the ramp at the end face correspond to the elastic piece, the first assembly component and the second assembly component are in a locked state, and when the unlocking sides of the ramp at the end face correspond to the elastic piece, the first assembly component and the second assembly component are in an unlocked state.

In one embodiment, the first combination piece is a magnetic piece, and the second combination piece is a magnetic piece or a magnetically attractive piece.

In one embodiment, a fixed plate is provided, which is disposed on one side of the first body having the elastic piece. The fixed plate fixes the elastic piece and has a channel corresponding to the elastic piece, and the passage is connected to the first holding groove.

In one embodiment, the first assembly component has a first turn. The first turn is disposed on the side of an opening of the passage away from the elastic piece. A surface of the first turn has at least one latch. The second combination piece further includes a second turn disposed on the side of the ramp; a surface of the second turn has a plurality of depressions. The at least one latch of the first turn is engaged with one of the plurality of depressions of the second turn. The at least one latch of the first turn is engaged with one of the plurality of depressions of the second turn.

In one embodiment, the latch has a curved face, and the depressions have curved grooves. The latch slides in the plurality of depressions.

In one embodiment, one side of the first turn has a first marker, and one side of the second turn has a second marker. When the first marker is rotated corresponding to the second marker, the first assembly component and the second assembly component are in an unlocked state or a locked state.

In one embodiment, the elastic piece has two fixed portions and connection portions. The connection portions have two fixed portions at opposite ends, and the two fixed portions protrude toward an opening of the first holding groove.

In one embodiment, the fixed portion of the elastic piece has a first guide surface on one side relative to the second combination piece, and the locking side has a second guide surface on one opposite side relative to the first combination piece, wherein when an end face of the ramp is inserted into the first holding groove, the second guide surface of the locking side of the end face of the ramp naturally contacts and enters with the first guide surface of the elastic piece.

In one embodiment, the first combination piece has a through hole, and the second combination piece has a lug. One end of the lug is curved. One end of the lug is received in the through hole.

In one embodiment, an outer diameter length of the locking sides is greater than an outer diameter length of the unlocking sides.

In one embodiment, the elastic piece has a fixed latch on one side adjacent to the first body. The first body has a fixed depression on the opposite side relative to the elastic piece. The fixed latch of the elastic piece is engaged with the fixed depression of the first body.

The quick release structure of the present invention uses magnetic attraction to fix the first assembly component and the second assembly component together. During rotation of the first assembly component and the second assembly component, the two components can switch between a locked state and an unlocked state. When the first assembly component and the second assembly component are rotated to a locked state, in addition to being fixed magnetically, they are also limited by the internal structure. When the first assembly component and the second assembly component are rotated to an unlocked state, the two components are only fixed magnetically. By applying a force greater than the magnetic attraction, the second assembly component can be separated from the first assembly component. This allows for quick disassembly and quick assembly of the quick release structure of the present invention.

Other objectives, features and advantages of the present invention will be further understood from the further technological features disclosed by the embodiments of the present invention, wherein there are shown and described preferred embodiments of this invention, simply by way of illustration of modes best suited to carry out the invention.

### BRIEF DESCRIPTION OF THE DRAWINGS

The accompanying drawings presented herein serve to deepen the understanding of the present invention and are an integral part thereof. The illustrative embodiments and their explanations are provided to elucidate the present invention and do not impose any undue limitations on it. In the drawings:

FIG. 1 is a breakdown diagram of the quick release structure of the present invention;

FIG. 2 is another breakdown diagram of the quick release structure of the present invention;

FIG. 3 is a three-dimensional diagram of the unlocked state of the quick release structure of the present invention;

FIG. 4 is a cross-sectional view taken along the A-A′ line of FIG. 3;

FIG. 5 is a schematic diagram of the internal unlocking of the quick release structure of the present invention;

FIG. 6 is a three-dimensional diagram of the locked state of the quick release structure of the present invention;

FIG. 7 is a cross-sectional view taken along the B-B′ line of FIG. 6; and

FIG. 8 is a schematic diagram of the internal locking of the quick release structure of the present invention.

### DETAILED DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

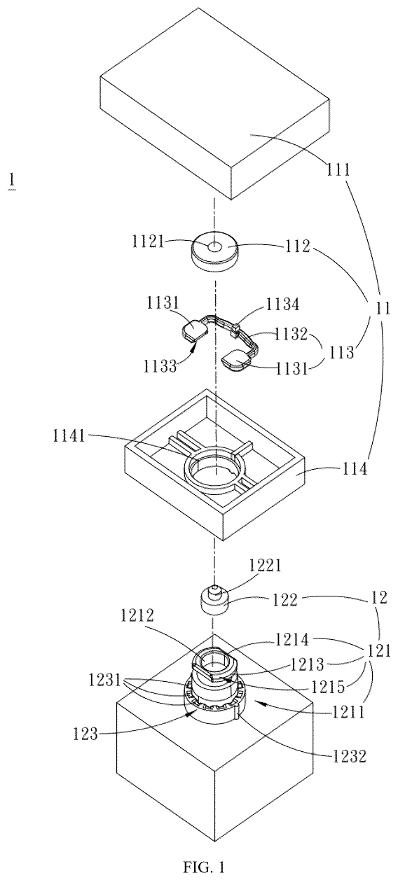

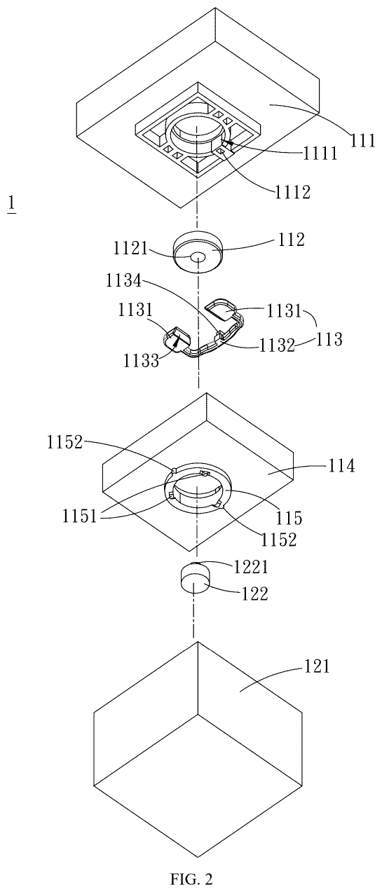

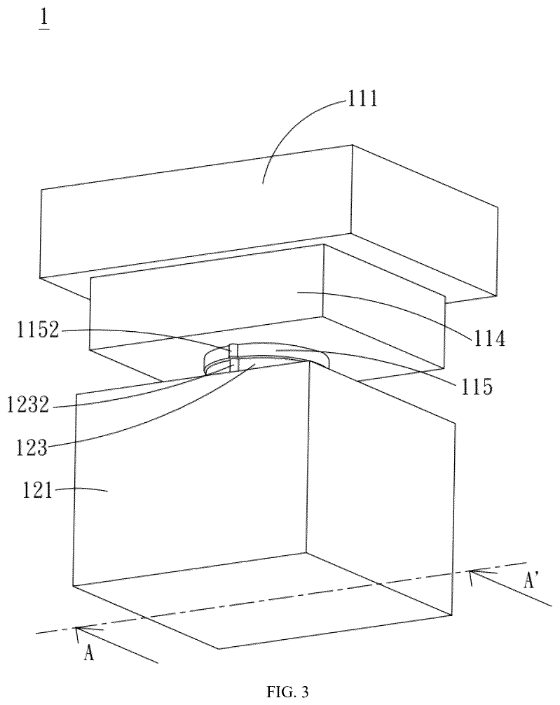

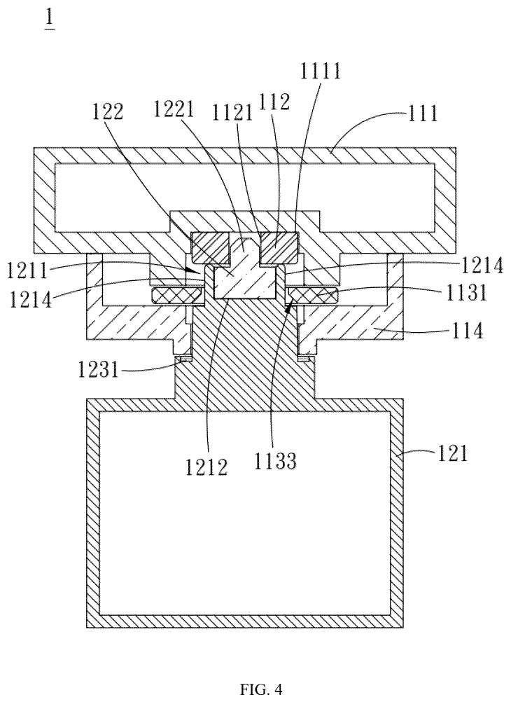

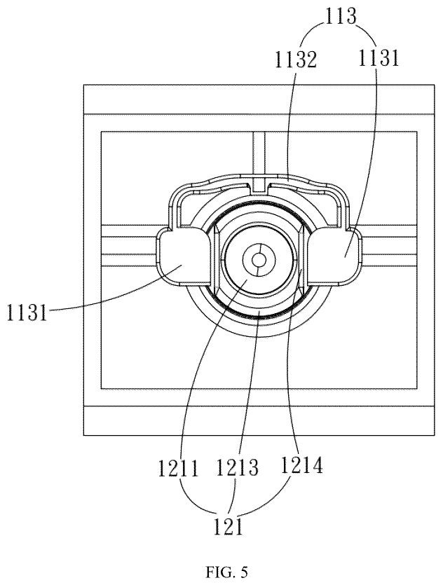

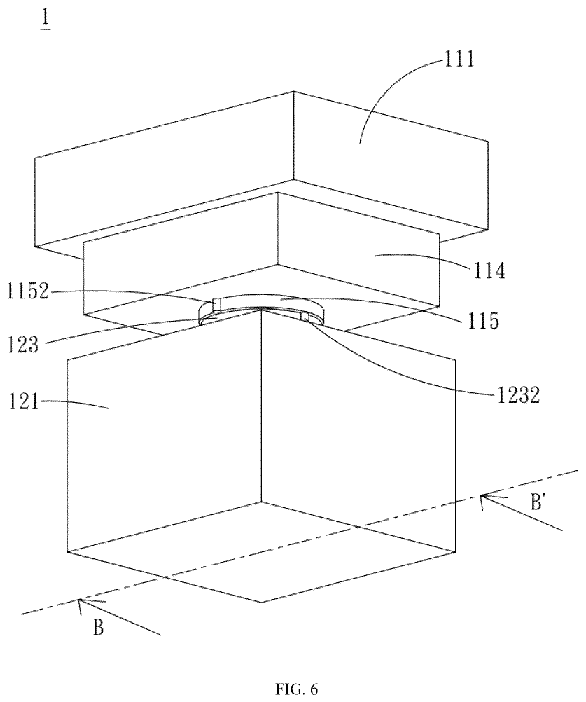

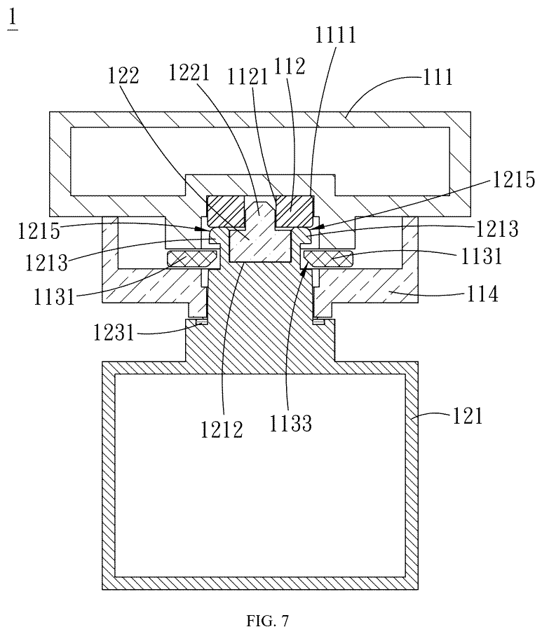

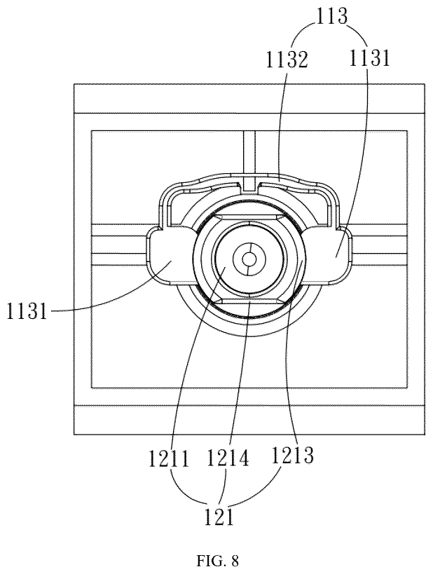

FIG. 1 is a breakdown diagram of the quick release structure of the present invention, FIG. 2 is another breakdown diagram, FIG. 3 is a three-dimensional diagram of the unlocked state, FIG. 4 is a cutaway view along the A-A′ line of FIG. 3, FIG. 5 is an internal unlocking diagram, FIG. 6 is a three-dimensional diagram of the locked state, FIG. 7 is a cutaway view along the B-B′ line of FIG. 6, and FIG. 8 is an internal locking diagram. As shown in the figures, the present invention provides a quick release assembly 1, which includes a first assembly component 11 and a second assembly component 12. The first assembly component 11 has a first body 111, a first combination piece 112, and an elastic piece 113. The first body 111 has a first holding groove 1111. The first combination piece 112 is disposed at a bottom of the first holding groove 1111. The elastic piece 113 is disposed at an opening of the first holding groove 1111. The second assembly component 12 has a second body 121 and a second combination piece 122. The second body 121 has a ramp 1211, and an end face of the ramp 1211 has a second holding groove 1212. The second combination piece 122 is disposed inside the second holding groove 1212. The end face of the ramp 1211 has two opposite locking sides 1213 and two opposite unlocking sides 1214 that surround it. The end face of the ramp 1211 of the second assembly component 12 is assembled into the first holding groove 1111 of the first assembly component 11, and the first combination piece 112 and the second combination piece 122 can mutually attract and/or be fixedly connected. Alternatively, as described above, the structure is limited in its relative position by the locking side 1213 of the ramp 1211 and the fixed portion 1131 of the elastic piece 113 so as to limit the relative positions of the first assembly component 11 and the second assembly component 12. When the locking sides 1213 of the end face of the ramp 1211 correspond to the elastic piece 113, the first assembly component 11 and the second assembly component 12 are in a locked state; i.e., the ramp 1211 of the second assembly component 12 cannot detach from the first holding groove 1111 of the first assembly component 11. When the unlocking sides 1214 of the end face of the ramp 1211 correspond to the elastic piece 113, the first assembly component 11 and the second assembly component 12 are in an unlocked state; i.e., the ramp 1211 of the second assembly component 12 can smoothly detach from the first holding groove 1111 of the first assembly component 11. The present embodiment does not limit the application of the first body 111 and the second body 121 in electronic devices or structures. The user can replace the first body 111 and the second body 112 with the suitable structures according to user needs, or set the first body 111 and the second body 112 on the required electronic devices or structures that require quick-release assembly.

As described above, the first assembly component 11 further includes a fixed plate 114. The fixed plate 114 is disposed on one side of the first body 111 having the elastic piece 113. The fixed plate 114 fixes the elastic piece 113; i.e., the fixed plate 114 and the first body 111 sandwich the elastic piece 113 together, wherein the elastic piece 113 has a fixed latch 1134 adjacent to one side of the first body 111, the one side of the first body 111 faces the elastic piece 113, and the first body 111 has a fixed depression 1112 relative to the elastic piece 113. The fixed latch 1134 of the elastic piece 113 is inserted into the fixed depression 1112 of the first body 111, thus limiting the position of the elastic piece 113 relative to the first body 111, such that the elastic piece 113 is fixed to the opening of the first holding groove 1111. The fixed plate 114 has a passage 1141, which corresponds to the elastic piece 113, and the passage 1141 is connected to the first holding groove 1111, wherein the elastic piece 113 has two fixed portions 1131 and connecting portions 1132. The connecting portions 1132 have two ends extending to two fixed portions 1131 respectively. The two fixed portions 1131 protrude into the opening of the first holding groove 1111.

Referring to FIG. 4 and FIG. 5, the distance between the two fixed portions 1131 adjacent to each other on the side of the elastic piece 113 is greater than the outer diameter length of the two opposite unlocking sides 1214. Thus, when the unlocking sides 1214 on the end face of the ramp 1211 correspond to the fixed portions 1131 of the elastic piece 113, the unlocking sides 1214 are not limited or affected by the fixed portions 1131; i.e., the ramp 1211 of the second assembly component 12 can freely enter and exit the first holding groove 1111 of the first assembly component 11. Referring to FIG. 6, the distance between the two fixed portions 1131 adjacent to each other on the side of the elastic piece 113 is less than the outer diameter length of the two opposite locking sides 1213. Thus, when the locking sides 1213 on the end face of the ramp 1211 correspond to the fixed portions 1131 of the elastic piece 113, the locking sides 1213 are limited or affected by the fixed portions 1131; i.e., the ramp 1211 of the second assembly component 12 is limited to being inside the first holding groove 1111 of the first assembly component 11.

As described above, the outer diameter length of the two opposite locking sides 1213 is greater than the outer diameter length of the two opposite unlocking sides 1214, wherein the sides of the two opposite locking sides 1213 are arc-shaped sides, and the sides of the two opposite unlocking sides 1214 are straight sides.

In addition, when the ramp 1211 of the second assembly component 12 enters the first holding groove 1111 of the first assembly component 11 with the unlocking side 1214, the unlocking side 1214 of the ramp 1211 will not be limited by the fixed portions 1131 of the elastic piece 113. When the ramp 1211 of the second assembly component 12 enters the first holding groove 1111 of the first assembly component 11 with the locking side 1213, the locking side 1213 of the ramp 1211 will be affected by the fixed portions 1131 of the elastic piece 113, wherein one side of the fixed portions 1131 of the elastic piece 113 relative to the second assembly component 12 has a first guide surface 1133 and one side of the two opposite locking sides 1213 relative to the first assembly component 11 has second guide surfaces 1215. When the end face of the ramp 1211 is inserted into the first holding groove 1111, the second guide surface 1215 of the locking sides 1213 of the end face of the ramp 1211 naturally contacts the first guide surface 1133 of the elastic piece 113, allowing the ramp 1211 to push open the elastic piece 113 such that the end face of the ramp 1211 can enter the first holding groove 1111. The second guide surface 1215 and the first guide surface 1133 help the end face of the ramp 1211 to be inserted into the first holding groove 1111 such that the second assembly component 12 can be installed inside the first assembly component 11. Thus, in the present embodiment, the ramp 1211 of the second assembly component 12 inserted into the first holding groove 1111 will not be limited; i.e., regardless of whether the locking side 1213 or the unlocking side 1214 of the ramp 1211 corresponds to the fixed portions 1131 of the elastic piece 113, they will not be limited during assembly.

In the present embodiment, when the end face of the ramp 1211 is inserted into the first holding groove 1111, the end face has a second combination piece 122, and the inside of the first holding groove 1111 has a first combination piece 112. The first combination piece 112 has a through hole 1121. The second combination piece 122 has a lug 1221, which is a cylindrical body, and one end of the lug 1221 also has an arc face.

One end of the lug 1221 of the second combination piece 122 is inserted into the through hole 1121 of the first combination piece 112. The lug 1221 can also be other shapes that can be inserted into the through hole 1121. When the second assembly component 12 is rotated relative to the first assembly component 11, the arc face of one end of the lug 1221 of the second combination piece 122 can rotate inside the through hole 1121 of the first combination piece 112. The structure of the cylinder and the hole can effectively stabilize the first assembly component 11 and the second assembly component 12 such that the aforementioned rotation process is not prone to shaking.

To further elaborate, the first combination piece 112 can be a magnetic piece, and the second combination piece 122 can be either a magnetic piece or a magnetic attachment, where the magnetic piece is various magnetic structures and the magnetic attachment is a metal material that can be attracted by a magnet. The present embodiment does not limit the magnetic structure relationship between the first combination piece 112 and the second combination piece 122. The first combination piece 112 and the second combination piece 122 can be adjusted according to the user's needs to be magnetic pieces or magnetic attachments for mutual magnetic fixation. In the present embodiment, in addition to mutual magnetic fixation, the first combination piece 112 and the second combination piece 122 can also fit into each other, thus strengthening the structural connection strength between the first combination piece 112 and the second combination piece 122. Furthermore, the first combination piece 112 and the second combination piece 122 can also be not limited to magnetic materials. Users can select the materials and structures of the first combination piece 112 and the second combination piece 122 according to their needs.

In the present embodiment, referring to FIG. 6 to FIG. 8, during the combination and fixing of the second assembly component 12 and the first assembly component 11, the ramp 1211 of the second assembly component 12 is inserted into the first holding groove 1111 of the first assembly component 11, and the second combination piece 122 of the second assembly component 12 is mutually attracted and fixed with the first combination piece 112 of the first assembly component 11. At the same time, when the locking side 1213 on the end face of the ramp 1211 corresponds to the fixed portions 1131 of the elastic piece 113, the locking side 1213 is limited by the fixed portions 1131. Thus, the second assembly component 12 and the first assembly component 11 are locked together.

Referring to FIG. 3 to FIG, during the disassembly and separation of the second assembly component 12 and the first assembly component 11, the second assembly component 12 is rotated relative to the first assembly component 11 such that the unlocking side 1214 on the end face of the ramp 1211 of the second assembly component 12 corresponds to the fixed portions 1131 of the elastic piece 113. The unlocking side 1214 is not limited or affected by the fixed portions 1131. The ramp 1211 of the second assembly component 12 can freely enter and exit the first holding groove 1111 of the first assembly component 11. When force is further applied to remove the second assembly component 12 and the force is greater than the magnetic force of the second combination piece 122 and the first combination piece 112 being mutually attracted, the second assembly component 12 can be disassembled from inside the first assembly component 11.

To further elaborate, the first assembly component 11 further includes a first turn 115, which is disposed on the fixed plate 114. The first turn 115 is located on the side of the opening of the passage 1141 far away from the elastic piece 113. The first turn 115 has at least one latch 1151 on its surface. The second assembly component 12 has a second turn 123, which is disposed on the side of the ramp 1211. The second turn 123 has a plurality of depressions 1231 on its surface. The at least one latch 1151 of the first turn 115 is inserted into one of the plurality of depressions 1231 of the second turn 123. Thus, when the first assembly component 11 is rotated relative to the second assembly component 12, the latch 1151 of the first turn 115 moves relative to the plurality of depressions 1231 of the second turn 123. The latch 1151 moving relative to the plurality of depressions 1231 will produce an upward and downward engagement sensation so that the user can clearly feel the relative rotation angle of the first assembly component 11 relative to the second assembly component 12. In other words, this design allows the combination pieces to rotate at each angle with clear detents and positioning. Due to the magnetic attraction, this will create a special sensation at each grade when rotated so that the user can more clearly know when the rotation is complete.

In addition, referring to FIG. 3 and FIG. 5, the side of the first turn 115 has a first marker 1152, and the side of the second turn 123 has a second marker 1232. When the first marker 1152 corresponds to the second marker 1232 during rotation, the first assembly component 11 and the second assembly component 12 are in either an unlocked state or a locked state. This makes it convenient for the user to know the status of the structure of the quick-release assembly 1.

Based on the above description, the quick release assembly of the present invention is fixed by magnetic attraction through the first assembly component and the second assembly component; i.e., by the magnetic force of the first body, the structure of the elastic piece is pushed apart such that it is combined. Even if non-magnetic materials are used, the structure of the elastic piece can be pushed apart by an external force. During the rotation process of the first assembly component and the second assembly component, the first assembly component and the second assembly component can switch between locked and unlocked states. When the first assembly component and the second assembly component are rotated to the locked state, the first assembly component and the second assembly component are fixed not only by magnetic attraction but also by the internal structure. When the first assembly component and the second assembly component are rotated to the unlocked state, the first assembly component and the second assembly component are only fixed by magnetic attraction. By applying a force greater than the magnetic attraction, the second assembly component can be disassembled from the first assembly component, and thus the design of the present invention is convenient for rapid disassembly and rapid assembly.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention in various embodiments and with various modifications as are suited to the particular use or implementation contemplated. It is intended that the scope of the invention be defined by the claims appended hereto and their equivalents, in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. in conjunction with a noun or element. Such terms should be understood as a nomenclature and should not be construed as giving the limitation on the number of the elements modified by such nomenclature unless a specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present invention is intended to be dedicated to the public regardless of whether the element or component is explicitly recited in the following claims.

What is claimed is:

1. A quick release structure, comprising:
a first assembly component, comprising:
a first body having a first holding groove;
a first combination piece disposed in the first holding groove; and
an elastic piece disposed at a mouth of the first holding groove; and
a second assembly component, comprising:
a second body having a ramp, an end face of the ramp having a second holding groove, the ramp having two locking sides and two unlocking sides at the end face, the end face of the ramp being assembled with the first holding groove of the first assembly component; and
a second combination piece disposed in the second holding groove,
wherein the first combination piece and the second combination piece are fixed together magnetically, and
wherein, when the locking sides of the ramp at the end face correspond to the elastic piece, the first assembly component and the second assembly component are in a locked state, and when the unlocking sides of the ramp at the end face correspond to the elastic piece, the first assembly component and the second assembly component are in an unlocked state.

2. The quick release structure as claimed in claim 1, wherein the first combination piece is a magnetic piece and the second combination piece is one of a magnetic piece and a magnetically attractive piece.

3. The quick release structure as claimed in claim 1, wherein the first combination piece further includes a fixed plate disposed on one side of the first body having the elastic piece,
wherein the fixed plate fixes the elastic piece and has a passage corresponding to the elastic piece, and
wherein the passage is connected to the first holding groove.

4. The quick release structure as claimed in claim 3, wherein the first combination piece further includes a first turn disposed on a side of an opening of the passage away from the elastic piece, a surface of the first turn has at least one latch, and
wherein the second combination piece further includes a second turn disposed on the side of the ramp, a surface of the second turn has a plurality of depressions, and the at least one latch of the first turn is engaged with one of the plurality of depressions of the second turn.

5. The quick release structure as claimed in claim 4, wherein the latch has a curved face, the plurality of depressions has curved grooves, and the latch is configured to slide in the plurality of depressions.

6. The quick release structure as claimed in claim 1, wherein one side of the first turn has a first marker and one side of the second turn has a second marker, and when the first marker is rotated corresponding to the second marker, the first assembly component and the second assembly component are in one of an unlocked state and a locked state.

7. The quick release structure as claimed in claim 1, wherein the elastic piece has two fixed portions and connection portions,
wherein opposite ends of the connection portions connect to the two fixed portions respectively, and
wherein the two fixed portions protrude toward an opening of the first holding groove.

8. The quick release structure as claimed in claim 7, wherein the fixed portion of the elastic piece has a first guide surface on one side relative to the second combination piece and the locking side has a second guide surface on one opposite side relative to the first combination piece, and
wherein, when an end face of the ramp is inserted into the first holding groove, the second guide surface of the locking side of the end face of the ramp naturally contacts and slides along the first guide surface of the elastic piece.

9. The quick release structure as claimed in claim 1, wherein the first combination piece has a through hole,
wherein the second combination piece has a lug, one end of which is curved, and
wherein the one end of the lug of the second combination piece is engaged with the through hole of the first combination piece.

10. The quick release structure as claimed in claim 1, wherein an outer diameter length of the locking sides is greater than an outer diameter length of the unlocking sides.

11. The quick release structure as claimed in claim 1, wherein the elastic piece has a fixed latch on one side adjacent to the first body,
wherein the first body has a fixed depression on the opposite side relative to the elastic piece, and
wherein the fixed latch of the elastic piece is engaged with the fixed depression of the first body.
